(19) United States
(12) Patent Application Publication
(10) Pub. No.: US 2005/0196173 A1
(43) Pub. Date: Sep. 8, 2005

(54) Receive optical assembly with angled optical receiver

(75) Inventors: Stefano Schiaffino, Pleasanton, CA (US); Alex Klajic, San Clarita, CA (US); Subra Nagarajan, Prior Lake, MN (US); Dincer Birincioglu, Foster City, CA (US); Mina Farr, Palo Alto, CA (US)

Correspondence Address: WORKMAN NYDEGGER;(F/K/A WORKMAN NYDEGGER & SEELEY), 60 EAST SOUTH TEMPLE, 1000 EAGLE GATE TOWER, SALT LAKE CITY, UT, 84111, US

(73) Assignee: Finisar Corporation

(21) Appl. No.: 10/954,091

(22) Filed: Sep. 28, 2004

Related U.S. Application Data
(60) Provisional application No. 60/533,880, filed on Dec. 29, 2003.

(51) Int. Cl. H04B 10/12

(52) U.S. Cl. 398/141

(57) ABSTRACT

A receive optical subassembly comprises a header assembly positioned inside an outer shell that interfaces with a receive optical fiber. The header assembly comprises an upper surface upon which one or more optical components can be mounted, the upper surface defined at least in party by a standard plane. The header assembly further comprises an angled surface that is angled with respect to the standard plane. The angled surface can comprise, for example, a sloped cavity stamped inside the header assembly, or an angled shim positioned on top of the header assembly upper surface. An optical receiver mounted on the angled surface receives an incoming optical signal but reflects at least a portion of stray optical signals away from the incoming optical signal.

### CROSS-REFERENCE TO RELATED APPLICATIONS

The present invention claims the benefit of priority to U.S. Provisional Patent Application No. 60/533,880, filed on Dec. 29, 2003, entitled “RECEIVE OPTICAL ASSEMBLY WITH ANGLED OPTICAL RECEIVER”, the entire contents of which are incorporated herein by reference.

### BACKGROUND OF THE INVENTION

1. The Field of the Invention

The present invention relates to systems, methods, and apparatus for maintaining fiber optic signal integrity within an optical subassembly. More particularly, exemplary embodiments of the invention concern receive optical subassemblies that include a photodetector having a detection surface oriented at a predetermined angle with respect to the optical fiber from which an optical signal is received.

2. Related Technology

Fiber optic technology is increasingly employed in the binary transmission of data over a communications network. Networks employing fiber optic technology are known as optical communications networks, and are typically characterized by high bandwidth and reliable, high-speed data transmission.

To communicate over a network using fiber optic technology, fiber optic components such as a fiber optic transceiver are used to send and receive optical data. Generally, a fiber optic transceiver can include one or more optical subassemblies (“OSA”) such as a transmit optical subassembly (“TOSA”) for sending optical signals, and a receive optical subassembly (“ROSA”) for receiving optical signals. More particularly, the TOSA receives an electrical data signal and converts the electrical data signal into an optical data signal for transmission onto an optical network. The ROSA receives an optical data signal from the optical network and converts the received optical data signal to an electrical data signal for further use and/or processing. Both the ROSA and the TOSA include specific optical components for performing such functions.

In particular, a typical TOSA includes an optical transmitter such as a laser diode, for sending an optical signal, and the TOSA further includes a monitor, such as a photodiode, that generates feedback concerning performance parameters of the laser, such as output power. The TOSA also includes a connection for a laser driver which is used to control the operation of the optical transmitter.

A typical ROSA includes an optical receiver component, such as a positive-intrinsic-negative photo diode (“PIN photo diode”) or avalanche photodiode (“APD”) that receives the optical data signal from the optical network. The optical receiver component converts the received optical data signal into an electrical data signal. The ROSA also typically includes a connection to a postamplifier that enables conditioning of the received optical data signal.

With more particular reference to the optical receiver, typical optical receivers include an active area that is oriented within the ROSA so as to receive an incoming optical data signal from an optical fiber that is connected with the ROSA. In particular, the optical signal arrives through an optical fiber which defines a longitudinal axis at the point where it connects to the ROSA. As such, the active area is substantially perpendicular to the axis of the optical data signal. While this configuration has proved satisfactory in older, low speed systems, the perpendicular orientation of the active area and the optical fiber has proved problematic when implemented in more recent high speed applications, such as 10.0 Gb/s systems.

In particular, a typical ROSA housing such as is used in a 10.0 Gb/s system includes a header upon which the optical receiver resides. The header is attached to a housing that supports a lens aligned with the optical receiver. This lens arrangement is desirable in that it contributes to a tight focus of the incoming optical signal. More particularly, the tight focus afforded by the lens enables effective and efficient use of the relatively small active area that is characteristic of many optical receivers.

Nonetheless, such a lens causes problems with typical optical receiver arrangements because any light that may be reflected for any reason by the optical receiver is typically directed back into the optical fiber, thus interfering with, and compromising, the received optical signals. More particularly, the “flat” arrangement of the optical receiver increases the likelihood that any reflections from the active area, or other parts of the optical receiver, will be directed back into the optical fiber.

Such reflections are, in most cases, characteristic of optical systems and cannot be eliminated but rather, must be controlled in a reliable and effective fashion. The sources of these errant reflections vary, but such reflections may occur when optical signals travel through materials having different indexes of refraction. A certain amount of reflection also occurs as a result of imperfections or scratches in optical components such as the focusing lens. Finally, non-focused, or stray portions of an optical signal may reflect off internal transceiver components.

Moreover, reflections that are incident on the receive fiber will also generally reflect off the fiber surface, as a secondary reflection, back towards the receive detector. This secondary reflection interferes with the receive signal, and can degrade any detected signal. In particular, conventional optical receivers have a detector surface (and fiber facets) that typically does not have an adequate anti-reflection coating (also referred as being an “uncoated fiber”). Furthermore, the receive fiber facet and the optical detector have parallel surfaces, and are positioned at conjugate (object and image) positions with respect to the receiver optics (lens). As such, this conventional position can cause the secondary reflections to also have an appreciable effect on the detected signal.

Related issues with typical optical receivers and ROSAs concern the positioning of the optical receiver relative to the lens. For example, small form factor OSAs that use a focusing lens may be rendered ineffective if the components of the ROSA, such as the lens, the end of the optical fiber, and the active area of the optical receiver are misaligned by even a few thousandths of an inch. Thus, the positioning of the optical receiver, relative to the lens for example, must be carefully controlled.

In recognition of the foregoing, and other problems in the art, what are needed are optical components that advantageously employ the active area of the optical receiver while reducing, or minimizing, the amount of light reflected back into the optical fiber, as well as the secondary reflection from the fiber surface back onto the detector. Such optical components should be suitable for use in high data rate systems and applications and should be compatible with optical subassembly alignment and construction processes. Finally, the optical components should be suited for use in receive optical subassemblies, among other things.

### BRIEF SUMMARY OF THE INVENTION

The present invention solves one or more of the foregoing problems in the art with receive optical subassemblies that are configured to reduce the amount of reflection, and hence signal distortion, that occurs when receiving an optical signal. In particular, the present invention provides for a novel ROSA that can reflect light away from incoming optical signals, and can be implemented with present manufacturing methods.

In one implementation, a ROSA includes a header having an upper surface defined in part by a standard plane, and an angled portion that is angled with respect to the standard plane. The optical fiber is connected to the ROSA header perpendicularly, such that the optical fiber delivers optical signals perpendicular to the standard plane. The ROSA optical receiver, such as a photodiode, is mounted on the angled portion of the header surface, such that the ROSA receives incoming optical signals at an angle relative to the detector surface. Alternatively, the optical receiver can be mounted on an angled material positioned on the ROSA header, such that the optical receiver component is angled with respect to the standard plane. Since the optical receiver receives the optical signals at an angle, fewer optical signals are reflected back into the receive fiber, hence reducing signal interference

In one implementation, the angle at which the photodiode component receives incoming optical signals can be adjusted based on the type of network communication. For example, one angle can be suitable for optical signals in a 2.0 Gigabit network, whereas another angle can be suitable for optical signals in a 10.0 Gigabit network, depending on the network tolerance to back reflections. Furthermore, the position of the optical receiver inside the ROSA header provides some flexibility with ROSA alignment procedures involving a lens or a glass plate. Implementations of the present invention, therefore, flexibly provide appropriate optical receiver positioning that is optimized for optical signal clarity, and can be implemented in a variety of ROSA designs.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates an optical transceiver comprising a TOSA and a ROSA in accordance with an implementation of the present invention, wherein the ROSA comprises a ROSA header illustrated in phantom;

FIG. 2A illustrates an exploded perspective view of the ROSA header depicted in FIG. 1, wherein a photodiode is positioned inside an angled cavity of the ROSA header;

FIG. 2B illustrates an exploded side view of the ROSA header depicted in FIG. 1, wherein the photodiode is positioned inside an angled cavity of the ROSA header;

FIG. 2C illustrates an exploded side view of the ROSA header depicted in FIG. 1, wherein the photodiode is positioned on top of a angled material;

FIG. 2D illustrates a side view of the ROSA header depicted in FIGS. 2A-2C, wherein the ROSA header comprises a cavity defined by a first angle θ;

FIG. 2E illustrates a side view of the ROSA header depicted in FIGS. 2A-2C, wherein the ROSA header comprises a cavity defined by a second angle θ;

FIG. 3A illustrates a conceptual view of an optical receiver in positional relation to a lens, based on a magnification ratio;

FIG. 3B illustrates a side view of a ROSA header comprising a lens cap that is inserted into a ROSA cavity a first distance; and

FIG. 3C illustrates a side view of the ROSA header depicted in FIG. 3B, wherein the ROSA header is inserted inside the ROSA cavity a second distance.

### DETAILED DESCRIPTION OF THE PREFERRED EMBODIMENTS

The present invention relates generally to receive optical subassemblies that are configured to reduce the amount of reflection, and hence signal distortion, that occurs when receiving an optical signal. In particular, the present invention provides for a novel ROSA that can reflect light away from incoming optical signals, and can be implemented with present manufacturing methods.

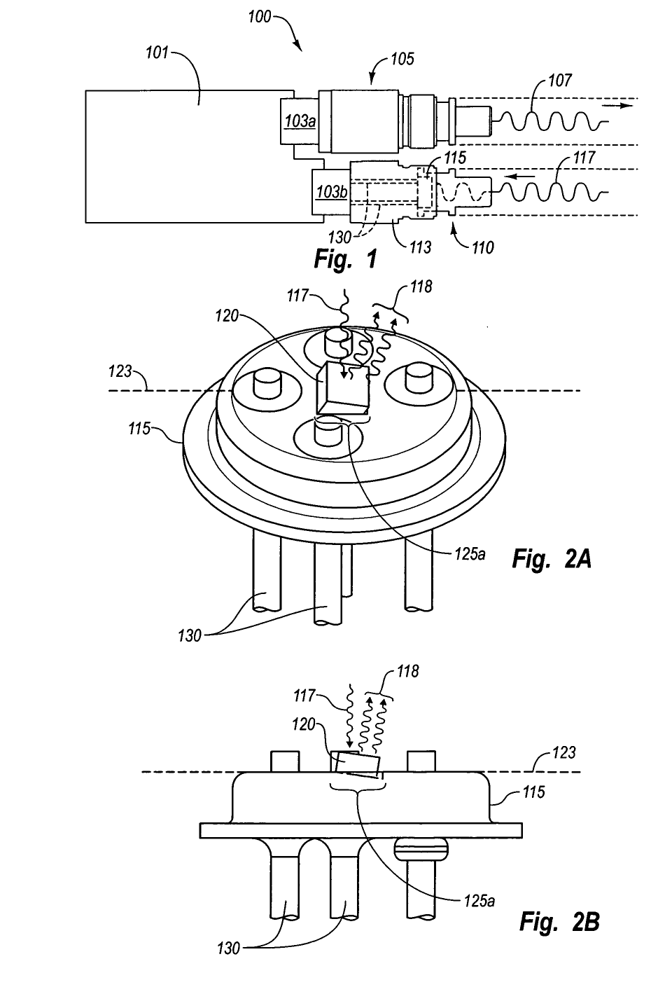

FIG. 1 illustrates one implementation of an optical transceiver 100, which comprises a TOSA 105 that generates an outgoing optical signal 107, and comprises a ROSA 110, which receives an incoming optical signal 117. The TOSA 105 and the ROSA 110 are each connected to a transceiver substrate 101 via corresponding flex circuits 103a-b. The ROSA 110 further comprises a ROSA header 115 enveloped by a ROSA outer shell 113 (or “housing”).

The ROSA header 115 comprises a plurality of electrical leads 130 (or “feed-throughs”) that extend through the end of the ROSA 110 outer shell 11 3, and connect to the corresponding flex circuit 103a-b. Generally, such electrical leads 130 can provide power and data transmission, and can monitor signal transmission between the transceiver substrate and any optical components that are mounted on the ROSA header 115 surface. Exemplary such optical components include optical receivers (e.g., PIN photodiodes and APDs) 120, transimpendance amplifiers, and capacitors.

The orientation and positioning of the optical receiver 120 may vary, depending upon the type of optical receiver 120 employed. For example, a PIN photodiode may be employed in a “front illuminated” disposition where the signal from the optical fiber is received at an active area on the front of the PIN photodiode. As another example, an APD may be employed in a “back illuminated” disposition where the signal from the optical fiber is received at an active area on the back of the APD.

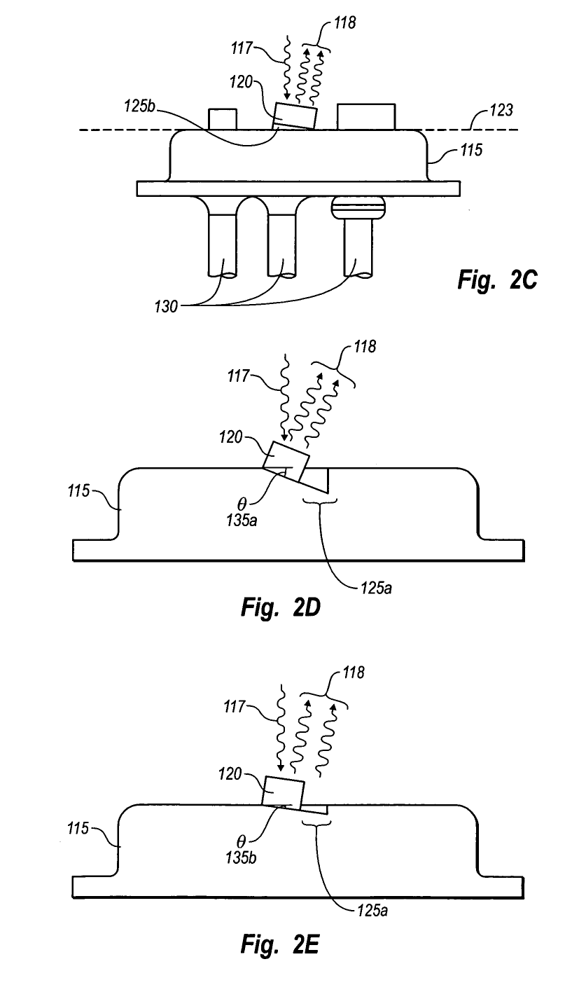

As indicated in FIGS. 2A-2C, an optical receiver 120, such as a photodiode, is mounted on the surface of the header 115. The conventional optical receiver 120 can be mounted on a submount (not shown), which, in turn, would be mounted in the header 115 surface. The submount is a separate optical component transmitting electrical signals from the optical receiver 120 to another component on the transceiver substrate 101. The submount, however, is omitted from these Figures simply for purposes of convenience.

As shown in FIG. 2A, the optical receiver 120 is positioned at an angle relative to an upper surface of the ROSA header 115, defined by the standard plane 123. In general, the angle of the optical receiver 120 can be described in terms of an angle θ, where θ is the angle of the surface on which the optical receiver 120 sits, relative to the standard plane 113. As will be appreciated from the present specification and claims, any stray or back-reflected optical signals 118, therefore, are at an angle of 2×θ relative to the incoming optical signals 117. As such, the angle of the optical receiver 120 allows for a reduction in interference due to stray optical signals.

This angled positioning may be achieved in a variety of ways. For example, FIGS. 2A-2B show that the optical receiver 120 is positioned inside an angled cavity 125a, formed in the ROSA header 115. While, on the other hand, FIG. 2C shows that the optical receiver 120 is positioned alternatively on an angled shim 125b, such that the optical receiver 120 is nevertheless at an angle relative to the standard plane 123. As such, any structure(s) or combination thereof that are effective in positioning the surface of the optical receiver 120 at a desired angle relative to the standard plane 123 may be appropriate.

With respect to the angled cavity implementation depicted in FIGS. 2A-2B, the ROSA header 115 can be formed of a single piece of material, such as metal, by a stamping process. In such a manufacturing process, the die that is used to stamp the header can comprise a protrusion, which, when stamped into the piece of material, forms the reciprocal shape, or the angled cavity 125a in the header 115. Thus, when the optical receiver 120 is positioned in the angled cavity 125a, the active portion of the optical receiver 120 forms a predetermined angle with the standard plane 123 defined by the ROSA header 115. In one implementation, this angle is from about 7° to about 8°. In another implementation, the angle is from about 9° to about 11°. However, header 115 can be manufactured to have an angled cavity of virtually any angle.

Of course, the angled orientation of the optical receiver 120 may be achieved in a wide variety of ways. As shown in FIG. 2C, for example, the ROSA header 115 does not necessarily include a stamped cavity, but rather a raised portion 125b, such as an angled shim (or other structure of comparable functionality). In such an implementation, the optical receiver 120 is attached to the raised portion 125b, such that the active area of the optical receiver 120 is nevertheless at a defined angle relative to the standard plane 123. Raised portion 125b (or shim) can be configured to implement virtually any angle, for example, in a range from about 7° to about 11°, as appropriate.

One will also appreciate from the present specification and claims that the geometric aspects of the angled cavity, such as the positioning, size and angle, and relative position of the cavity, may be varied with respect to the header, as necessary to suit the requirements of a particular application. In general, since the angle of the stray optical signals 118 is different by a factor of 2θ relative to the incoming optical signals 117, there is a reduction in optical signal interface. Nevertheless, the angle θ may be varied for such requirements as, for example, the data rate of the associated optical system, and the magnification ratio associated with the ROSA.

FIGS. 2D-2E illustrate alternative implementations of a ROSA header 115 having different angles θ 135a, and θ 135b present in the cavity 125a slopes. The angle θ relative to the standard plane 123 should be geared toward optimizing the active portion of the optical receiver (i.e., photodiode) while, at the same time, adequately reflecting stray optical signals (e.g., signals 118).

For example, a more pronounced angle (e.g., θ 135a) will reflect a greater amount of stray optical signals 118 away from the incoming optical signal 117, but may limit the amount of the optical signal 117 received by the optical receiver 120. By contrast, a smaller angle (e.g., θ 135b) will reflect a greater amount of stray optical signal 118 toward the incoming optical signal 117, but also positions the optical receiver 120 to receive the greatest amount of incoming optical signal 117. The foregoing description of different angles θ applies equally to use of a raised portion 125b (or shim), rather than a stamped cavity 125a.

Depending on the application, a manufacturer may optimize the particular angle θ relative to the standard plane 123 for the operating requirements and parameters of the relevant systems and components. In particular, a greater angle θ (e.g., from about 9° to about 11°) may be appropriate when the optical receiver 120 is used in connection with 10.0 Gigabit network communications. By contrast, a lesser angle θ (e.g., from about 6° to about 8°) may be appropriate where the optical receiver 120 is employed in connection with 2.0 Gigabit network communications.

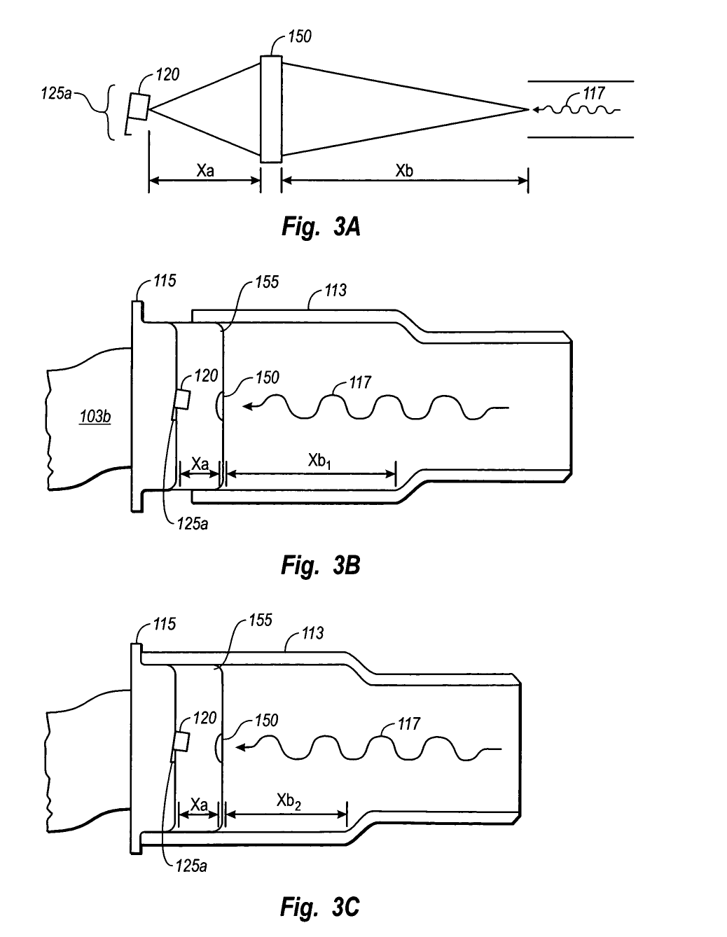

Position of the angled detector could also be adjusted in such way that, in addition to the angled optical detector, the fiber is set in an off-axis position with respect to an imaging lens and the optical detector. To achieve further reduction of reflected light back into the fiber, the optical detector is placed towards the lower side of the angled surface, making the incidence angle on the optical detector even larger than the original tilt angle of the optical detector. Thus, the reflected light back on the fiber ends up even farther away from the core of the fiber on the return path, or is completely blocked by a lens aperture (e.g., aperture 155, FIGS. 3A-3C).

In addition to the foregoing benefits of minimizing interference from reflected optical signals, the implementations described herein provide other advantages that can be useful when aligning a given ROSA during assembly. In particular, implementations of the present invention can also help solve issues associated with header alignment in relation to a given lens magnification ratio. Such implementations may typically depend on whether or not the ROSA includes a glass window (not shown) or a focusing lens and lens cap assembly.

For example, as shown in FIGS. 3A-3C, ROSAs 110 that include a focusing lens 150 and lens cap 155 assembly may be optimized based on positioning of the optical receiver 120, the lens 150, and the entry point of the incoming optical signal 117 relative to each other. This positioning is based at least in part on the lens's 150 magnification ratio. For example, as shown in FIG. 3A, correct positioning of components within a certain magnification ratio depends on essentially two distances, “Xa”, and “Xb”, where “Xa” is the distance between the optical receiver 120 and the lens 150 aperture 155, and “Xb” is the distance between the exit of the incoming optical signal 117 from the optical fiber into the ROSA 110, and the lens 150.

As shown in FIG. 3B, for example, the optical receiver 120 is at a distance “Xa” from the lens 150, while the lens 150150 is at a distance “Xb₁” from the entry of the incoming optical signal 117. As shown in FIG. 3C, the optical receiver 120 is still at a distance “Xa” from the lens 150, while the lens 150 is closer “Xb₂” to the entry of the incoming optical signal 117. As such, the ROSA header 115 in FIG. 3B is further away from the entry of the incoming optical signal 117 than in FIG. 3C.

During manufacture, the manufacturer will need to move the optical receiver 120 further away from the lens 150, which is closer to the transceiver substrate 101. This movement may cause kinking, or breakage, of the flex circuit 103b, which connects the header 115 to the transceiver substrate 101. Since this distance, however, which the manufacturer must usually move the header 115 backward is fairly small, (e.g., 12 thousandths of an inch), the angled cavity 125a provides much of this change in distance “Xa” without necessarily needing to move the header 115 backward. Thus, the angled cavity 125a in the header 115 enables the position of the optical receiver 120 to be adjusted relative to the ROSA housing 113, while the ROSA housing 113 is maintained in a desired position.

In a similar manner, the raised portion 125b in the header 115 can also compensate for arrangements where a glass plate (not shown) is interposed between the fiber end and the lens 150. In such arrangements, the glass plate will typically need the optical receiver 120 and lens to be moved away from the fiber a certain distance. This distance can be partially, if not completely, accommodated by fashioning a header having angled cavity 125a, or raised portion 125b, of the appropriate depth/height. Thus, the optical receiver 120 can be positioned relatively further away from the lens 150, without necessitating a corresponding movement of the header assembly 115.

The stamped cavity 125a implementation of the ROSA header 115 also facilitates the assembly of devices that include a glass plate (not shown) that extend between the incoming signal 117 entry point an the lens 150. For example, a light cure, or temporary, epoxy is sometimes used in the assembly of the ROSA housing 113. This light cure epoxy is typically used to attach the header 115 assembly to the housing 113. The presence of the stamped cavity 125a in the header 115 introduces the ability to move the optical receiver 120 relative to the lens 150, so as to at least partially compensate for the presence of the glass plate (not shown), and thereby preclude the need to move the header assembly 115 relative to the ROSA housing 113.

Embodiments of the invention are useful in other situations as well. For example, it is sometimes the case that the optical receiver 120 needs to be positioned closer to the lens 150, and/or fiber end than the header assembly 113 would otherwise allow. In such cases, a header assembly 115 with a raised portion 125b of predetermined height (e.g., FIG. 2C) may be employed to position the optical receiver 120 a desirable distance from the lens 150 and/or fiber end (point at which the incoming optical signal 117 enters the ROSA 110).

As should be apparent after having reviewed this description, embodiments of the invention are well suited for use in positioning an optical receiver 120 in a desired location relative to optical subassembly components such as, but not limited to, lenses, windows, and fiber ends. Additionally, such embodiments are likewise well suited for use in facilitating alignment and positioning of other components, such as the header assembly 115 and ROSA housing 113, for example, relative to each other. Accordingly, the scope of the invention should not be construed to be limited to any particular header or header assembly implementation, or to any particular combination of optical subassembly components.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

1. A receive optical subassembly, comprising:
a housing configured to receive an optical fiber end;
a header assembly configured to fit at least partially within the housing, the header assembly comprising:
a header having an angled surface relative to a standard plane of the header assembly;
an optical receiver being mounted at least partially upon the angled surface, such that the optical receiver is positioned to receive at least a portion of an optical signal introduced into the housing by an optical fiber end.

2. The receive optical subassembly as recited in claim 1, wherein the optical receiver is one of a PIN photodiode and an APD.

3. The receive optical subassembly as recited in claim 1, wherein the angled surface is positioned about the standard plane, and comprises at least one of an angled cavity and an angled shim.

4. The receive optical subassembly as recited in claim 1, further comprising a trans-impedance amplifier coupled to the optical receiver.

5. The receive optical subassembly as recited in claim 1, wherein the angled surface is sloped from about 6° to about 8° relative to the standard plane.

6. The receive optical subassembly as recited in claim 1, wherein the angled surface is sloped from about 9° to about 11° relative to the standard plane.

7. The receive optical subassembly as recited in claim 1, wherein the angled surface is optimized for at least one of 2.0 and 10.0 Gb/s optical network communication speeds.

8. An optical transceiver configured to minimize interference from stray optical signals that may result from an incoming optical signal comprising:
a transmit optical subassembly;
a receive optical subassembly, the receive optical subassembly having an optical receiver mounted on an angled surface of a header assembly, such that at least part of an incoming optical signal received from an optical fiber passes to the optical receiver, and at least part of the incoming optical signal is reflected away from the incoming optical signal.

9. The optical transceiver as recited in claim 8, wherein the angled surface comprises a cavity embedded in the header assembly.

10. The optical transceiver as recited in claim 8, wherein the angled surface comprises a shim that is mounted on the header assembly.

11. The optical transceiver as recited in claim 8, wherein the optical receiver is one of a PIN photodiode and an APD.

12. The optical transceiver as recited in claim 8, wherein the positioning of the optical receiver is optimized for system parameters.

13. The optical transceiver as recited in claim 12, wherein the optical receiver position is optimized by the angle of the angled surface, such that the optical receiver is optimized for one of 2.0 Gb/s or 10.0 Gb/s network communication speed.

14. The optical transceiver as recited in claim 12, wherein the optical receiver position is optimized by distance from one of a lens or a glass plate that is positioned in between the incoming optical signal and the optical receiver.

15. A method of manufacturing a receive optical subassembly configured to reflect stray optical signals away from an incoming optical signal, comprising:
forming a receive outer shell suitable to interface with an optical fiber on one end, and comprising a cavity on an opposing end for receiving one or more optical components;
forming a header assembly configured to be at least partially inserted inside the cavity of the receive outer shell, the header assembly comprising an upper surface defined in part by a standard plane;
forming an angled surface on the upper surface of the header assembly, wherein the angled surface is optimized for a network communication speed, and wherein the angled surface is angled with respect to the standard plane;
positioning an optical receiver on the angled surface; and
inserting the header assembly into the cavity of the outer shell.

16. The method as recited in claim 15, further comprising aligning a lens cap about the header assembly, wherein the lens cap comprises a lens having a magnification ratio that focuses the incoming optical signal toward the optical receiver consistent with the magnification ratio.

17. The method as recited in claim 16, further comprising positioning the header assembly inside the cavity of the outer housing, such that the header assembly is positioned consistent with the magnification ratio closer to or further away from the end for receiving the optical fiber.

18. The method as recited in claim 15, wherein the angle of the angled surface is from 6° to 8° or from 9° to 11° relative to the standard plane.

19. The method as recited in claim 16, wherein forming an angled surface comprises stamping the header assembly to comprise an angled cavity,

20. The method as recited in claim 16, wherein forming an angled surface comprises positioning an angled shim on the upper surface of the header assembly, or within a cavity of the header assembly.
